(19) United States
(12) Patent Application Publication
(10) Pub. No.: US 2001/0031570 A1
(43) Pub. Date: Oct. 18, 2001

(54) Flap actuation mechanism for an electronic unit

(75) Inventors: Seita Horikoshi, Zama-shi (JP); Hideyuki Usui, Chigasaki-shi (JP)

Correspondence Address: IBM Corporation, Personal and Printing Systems Group, Dept. 9CCA/Bldg. 002-2, P.O. Box 12195, Research Triangle Park, NC, 27709, US

(73) Assignee: International Business Machines Corporation, Armonk, NY (US)

(21) Appl. No.: 09/834,474

(22) Filed: Apr. 13, 2001

(30) Foreign Application Priority Data
Apr. 17, 2000 (JP) 2000-115763

(51) Int. Cl. H01R 13/44

(52) U.S. Cl. 439/137

(57) ABSTRACT

A flap actuation mechanism is provided with flaps for opening an aperture formed in the housing of a notebook sized personal computer. A first shaft portion and a second shaft portion rotatably support rotating plates bent and formed in the flaps and an insertion mouth is formed in the abutting surfaces of the flaps. An opening pin is inserted into the insertion mouth from the outside. The positions of the first shaft portion and the second shaft portion are set according to the height of the rotating plates so that the moment of rotation for opening the flap outside the housing is greater than the moment of rotation for rotating the flap inside the housing. With this, it becomes possible to reduce the height of the rotating plates and therefore the flap actuation mechanism can be made thin.

### FIELD OF THE INVENTION

The present invention relates to a mechanism for actuating a flap which protects a connector for an electronic unit, and more particularly to a flap actuation mechanism suitable for a connector connection between a portable computer and an extended unit.

### BACKGROUND OF THE INVENTION

While portable computers are lightweight and small and have excellent portability, they are subjected to a restriction on the functions that can be incorporated, as compared with desktop computers. On the other hand, there is a demand for using portable computers having the same functions as desktop computers in offices and households. To cope with this demand, extended units in the form of docking stations or port replicators have been provided which are designed to be detachably connected to a computer. A docking station is equipped with a drive bay for housing a drive unit, and an extended slot into which various option cards are inserted. It provides a drive unit, such as a hard disk, a DVD, a CD-ROM, etc., and a device extending function, such as a PCI extended card, an ISA extended card, a PC card, etc., to computers. A port replicator generally includes no active part and provides extended devices, such as a PC card slot, an I/O port connector (a mouse connector and a keyboard connector), a PC card controller, an EEPROM, etc.

The portable computer and the extended unit are each provided with connectors in order to connect both electrically. As the portable computer is handy to carry, and the operating conditions are severe, there is a need to protect the connector of the portable computer from the environment when the portable computer is not connected to the extended unit. As a method of protection, a flap opening and closing mechanism is provided in the housing of the computer corresponding to the position of the connector. When using the computer on its own, the flap is closed to protect the connector. When attaching the computer to the extended unit, the flap is automatically opened only when the position of the computer is aligned with and connected to the extended unit, and the connector on the computer side is exposed and connected to the connector on the extended unit side.

As an example of a conventional flap opening and closing mechanism, a description will hereinafter be given of a flap opening and closing mechanism 78 (see FIGS. 9 and 10) provided in a portable personal computer (hereinafter referred to as a PC).

As shown in FIG. 9, at the lower portion of the PC 80, a male connector 86 to be connected to an extended unit 82 is provided on the lower surface of a substrate 90 so that it faces down. In the extended unit 82 to be connected to this PC 80, a female connector 92 to be connected to the male connector 86 is provided so that it faces up.

In addition, an opening 104 corresponding to the male connector 86 is formed in the bottom of the housing 102 of the PC 80, and two flaps 110A, B for opening or closing the opening 104 are provided within the housing 102.

As shown in FIG. 10, rotating plates 114A are formed by bending both ends of the flap main body 112A of the flap 110A. The rotating plates 114A are rotatably supported by first shaft portions 116A, so the flap 110A is rotatable. Likewise, rotating plates 114B are provided on both ends of the flap main body 112B of the flap 110B. The rotating plates 114B are rotatably supported by second shaft portions 116B, therefore the flap 110B is rotatable.

In addition, in the abutting surfaces 118 of the flaps 110A, 110B there are formed insertion mouth 122 into which guide pins 120 provided in the extended unit 82 are inserted. Note that “the abutting surfaces” used in this specification shall mean side wall surfaces which abut each other when the two flaps are closed.

The guide pins 120 and the female connector 92 are formed integrally with each other. The top end of each guide pin 120 is formed into a cone, which is suitable to open the flaps 110A and 110B when inserted into the insertion mouth 122. Holes (not shown) to insert the guide pins 120 therein are formed integrally on both ends of the male connector 86. Although the connectors themselves cannot be manipulated to align them with each other when connecting the PC with the extended unit, if the PC is approximately positioned with respect to the extended unit, the guide pins 120 first open the flaps and then are inserted into the holes of the male connector 86, whereby the two connectors are accurately positioned and connected.

If the guide pins 120 are inserted into the insertion mouth 122 in attaching the PC 80 to the extended unit 82, force is exerted on the edges 122E of the insertion mouth 122 by the conical surfaces 120C of the guide pins 120 and therefore moments of rotation act on the flaps 110A, 110B, with the first and second shaft portions 116A and 116B as axes. The moments of rotation are directed in the directions of arrow U where the flaps 110A, 110B are opened outside the housing 102. With this, the flaps 110A, 110B are opened, and through the guide pins 120, the PC is guided to a position where the male connector 86 and the female connector 92 mesh. When the connection is completed, the flaps 110A, 110B are fully opened as shown in FIG. 11.

While, in the aforementioned description, the guide pins 120 are also used as pins for opening the flaps 110A, 110B to the outside, other known flap opening and closing mechanisms have included additional pins (not shown) for opening the flaps 110A, 110B to the outside are fixedly provided for the connecting.

Small electronic units, such as PC 80 and the like, tend to be made increasingly small and thin. Because of this, it would be desirable to reduce the height H1 (see FIG. 10) of the rotating plates 114 of the flap 110 to make the flap opening and closing mechanism 78 thin.

If the height H1 of the rotating plates 114 is reduced, however, there is a problem that the conventional flap opening and closing mechanism cannot perform a sufficient opening and closing operation. In attaching the PC to the extended unit, the flaps 110A and 110B must be rotated in the directions of arrow U shown in FIG. 10 in order to expose the male connector 86. If the radius H1 of rotation becomes smaller, the spacing between the abutting surfaces 118, i.e., the opening degree of the flaps, cannot be set sufficiently wide when the flaps are opened. Since the male connector 86 cannot be sufficiently exposed, the flaps will interfere with the male connector 86 or female connector 92.

To avoid this, it is considered that the spacing X between the first shaft portion 116A and the second shaft portion 116B is widened. However, even if only the spacing X is widened, the positions that the guide pin 120 first contact the edge 122E of the insertion mouth 122 at two points (hereinafter referred to as action points) will be located inside the first shaft portion 116A and the second shaft portion 116B, and moments of rotation will be applied to the flaps 110A and 110B in the opposite direction from the direction of arrow U. Thus, moment of rotation cannot be obtained in the directions of opening the flaps.

On the other hand, an attempt to obtain moment of rotation that can open the flaps has been made, by enlarging the insertion mouth 122 to increase the diameter of the edge 122E, and also by thickening the guide pins to widen the spacing between the action points. However, making the height H1 low means that the length from the surface of the flap main body to the surface of the male connector 86 or surface of the substrate 90 becomes shorter. The substrate will be provided with a large hole into which the thickest portion of the guide pin 120 is inserted. Therefore, since the substrate is subjected to a restriction on pattern formation, the length of the guide pin 120 also needs to be shortened.

If the guide pin 120 becomes short, the female connector 92 will reach the flap position and interfere, before the flaps 110A and 110B are fully opened. Furthermore, an attempt to open large flaps with respect to the small stroke of the guide pin 120 has been made by making the height of the conical portion of the guide pin 120 low. If the height of the conical portion is too low, however, there is a restriction that enough moment of rotation to open the flaps in the directions of arrows U cannot be obtained.

In addition, the guide pin and the hole, which fits on the pin, need to be formed integrally with the connector, because high precision is required at the contacting portions of the two connectors in order to perform positioning of the two connectors. Therefore, if the guide pin 120 is thickened, the connector itself will be increased in size and the opening degree of the flaps needs to be increased correspondingly. Because of this, it becomes increasingly difficult to make the height H1 low.

Moreover, an attempt has been made to open the flaps by providing dedicated members other than the guide pins. However, the angle of inclination of a surface constituting the action point of the dedicated member needs be a predetermined value or greater in order to exert moment which is enough to open the flaps at the point of action. For that reason, the height of the dedicated member must be made high. Even if the flaps can be opened, the dedicated members will collide with the substrate 90 and mounting of the PC cannot be performed.

### SUMMARY OF THE INVENTION

The present invention seeks to provide a flap opening and closing mechanism for protecting the connector of a thin electronic unit.

More specifically, it relates to a flap opening and closing mechanism which is capable of opening flaps without interfering with the connector, even when a distance from the flap surface to the connector is short.

An embodiment of the present invention relates to a flap actuation mechanism operable during connection of a first electronic unit, which is provided with a first connector, and a second electronic unit, which is provided with a second connector connectable with the first connector and flaps for protecting the second connector. The first electronic unit is equipped with an opening pin, which is urged in a direction of protrusion by an urging means and opens the flaps in connecting the first electronic unit and the second electronic unit. The opening pin is urged in the direction of protrusion by a spring, and if it strikes an inner portion of the second electronic unit, the spring is compressed and therefore the opening pin is depressed in a direction of the first electronic unit. The second electronic unit is equipped with a housing, an opening formed at the second connector portion of the housing, two flaps formed in the opening, and an insertion mouth formed in abutting surfaces of the two flaps so that it can engage with the opening pin when the first connector and the second connector are connected.

With the foregoing construction, the opening pin engages the insertion mouth and opens the flaps. In this embodiment, the spacing between the shafts on which the two flaps rotate is widened. Therefore, even if the second electronic unit is thin, a sufficient opening of the flaps can be obtained. Even if the distance between the shafts of the two flaps is widened, the opening pin can provide action points which have spacing corresponding to the widened distance, and the opening pin can be formed so that it has an inclined surface such that moment of rotation for opening the flaps can be obtained. The opening pin is urged by a spring which is enough to give moment of rotation for opening the flaps. When the opening pin collides with the substrate, etc., of the second electronic unit in the final stage of connecting the two electronic units, force applied by the substrate opposes the urging force and pushes the opening pin into the first electronic unit, so there is no possibility that the connecting operation will be disturbed. Therefore, the configuration of the opening pin can be determined according to the conditions of an action point and moment of rotation.

That is, even when the second electronic unit is thin and therefore the opening pin cannot take a sufficient stroke, the opening pin can be formed so that it has a sufficient height from the upper surface of the first connector. Therefore, there is no possibility that in the initial stage of opening the flaps, the opening pin will interfere with the first connector because of an insufficient opening degree of the flaps. In addition, while the opening pin can be provided with inclined surface that provides an action point, an angle which is formed by the inclined surface and flaps main body around the insertion mouth can be determined in order to give sufficient moment of rotation to the flaps, without being subjected to a restriction on the height.

Another embodiment of the present invention is directed to a portable computer and an extended unit, equipped with the above-mentioned flap actuation mechanism.

Embodiments of the present invention will hereinafter be described with reference to the accompanying drawings.

### BRIEF DESCRIPTION OF THE DRAWINGS

FIG. 1 is an exploded perspective view of a portable personal computer provided with a flap opening and closing mechanism of an embodiment of the present invention, an extended unit having also been shown;

FIG. 2 is an exploded perspective view showing the construction of the flap opening and closing mechanism of the embodiment of the present invention;

FIG. 3 is a sectional side view showing the state in which the opening pin abuts the flaps;

FIG. 4 is a part-enlarged perspective view showing the state in which the flaps begin to open;

FIG. 5 is a sectional side view showing the state in which the flaps start opening;

FIG. 6 is a sectional side view showing that the flaps are in a fully opened state;

FIG. 7 is a sectional side view showing that the opening pin has been depressed by the substrate;

FIG. 8 is a part-enlarged perspective view showing that the opening pin has been depressed by the substrate;

FIG. 9 is an exploded perspective view of a portable personal computer provided with a conventional flap opening and closing mechanism of an embodiment of the present invention, an extended unit having also been shown;

FIG. 10 is an exploded perspective view showing the construction of the conventional flap opening and closing mechanism; and

FIG. 11 is a perspective view showing the state in which the flaps in the conventional flap opening and closing mechanism are open in a connector connected state.

### DETAILED DESCRIPTION OF THE INVENTION

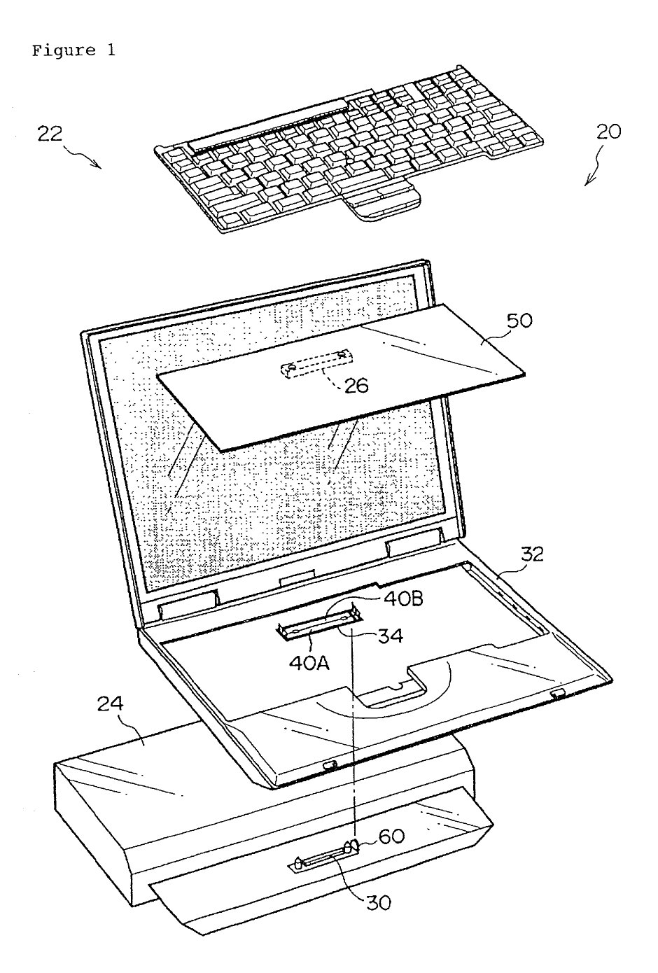

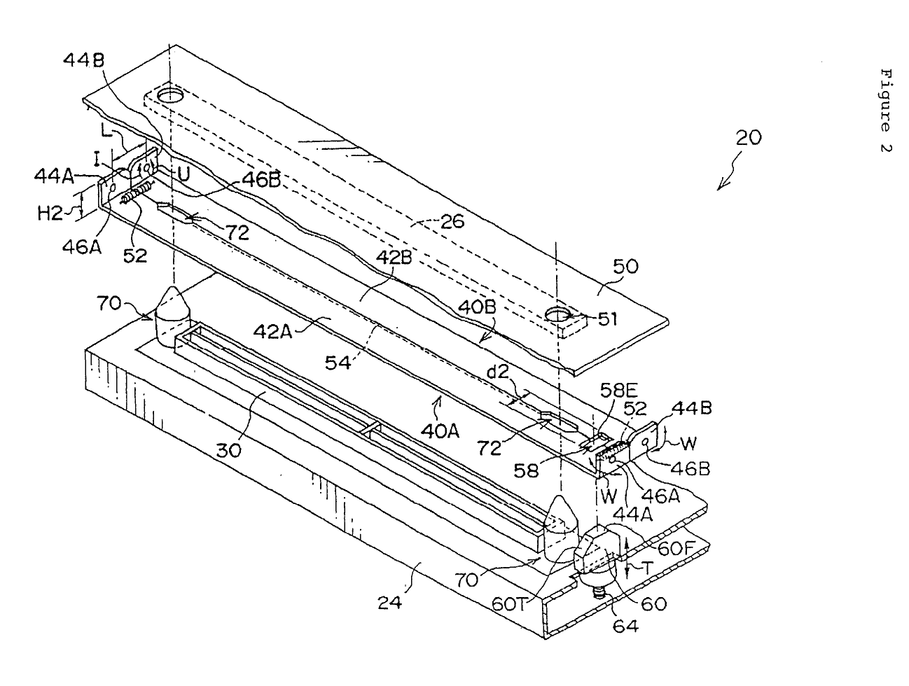

A flap opening and closing mechanism 20 as shown in FIGS. 1 and 2, provided in a portable personal computer and an extended unit, is taken as an example of an embodiment of the present invention.

As shown in FIG. 1, at the lower portion of the portable personal computer (hereinafter referred to as a PC) 22, a low height type male connector 26 to be connected to the extended unit 24 is provided on the backside of a substrate 50 so that it faces down, and a female connector 30 to be connected to the male connector 26 is provided on the extended unit 24 so that it faces up.

In addition, an opening 34 corresponding to the male connector 26 is formed in the bottom side of the housing 32 of the PC 22, and two flaps 40A, 40B for opening or closing the opening 34 are provided within the housing 32 as shutters.

As shown in FIG. 2, rotating plates 44A are formed by bending both ends of the flap main body 42A of the flap 40A. The rotating plates 44A are rotatably supported by first shaft portions 46A, so the flap 40A is rotatable. Similarly, rotating plates 44B, formed by both ends of the flap main body 42B of the flap 40B. The rotating plates 44B are rotatably supported by second shaft portions 46B, therefore the flap 40B is rotatable.

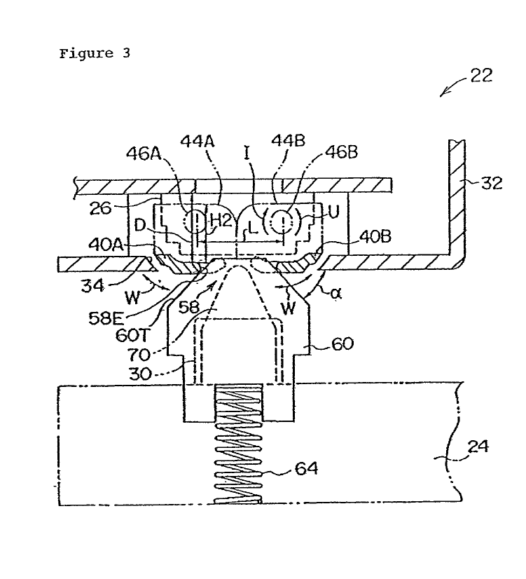

The height H2 of the rotating plates 44A, 44B is low compared with the height H1 of the rotating plates 14A, 14B of the conventional flap opening and closing mechanism 78. With this, the spacing D between the substrate 50 and the flap main bodies 42A, 42B (see FIG. 3) is reduced to 6.2 mm.

Also, tension coil springs 52 are mounted on the upper surfaces (inner surface) of both end portions of the flap main bodies 42A, 42B. When the extended unit 24 is not connected to the PC 22, the flaps 40A, 40B are caused to be in a closed state by the tension force of the tension coil springs 52.

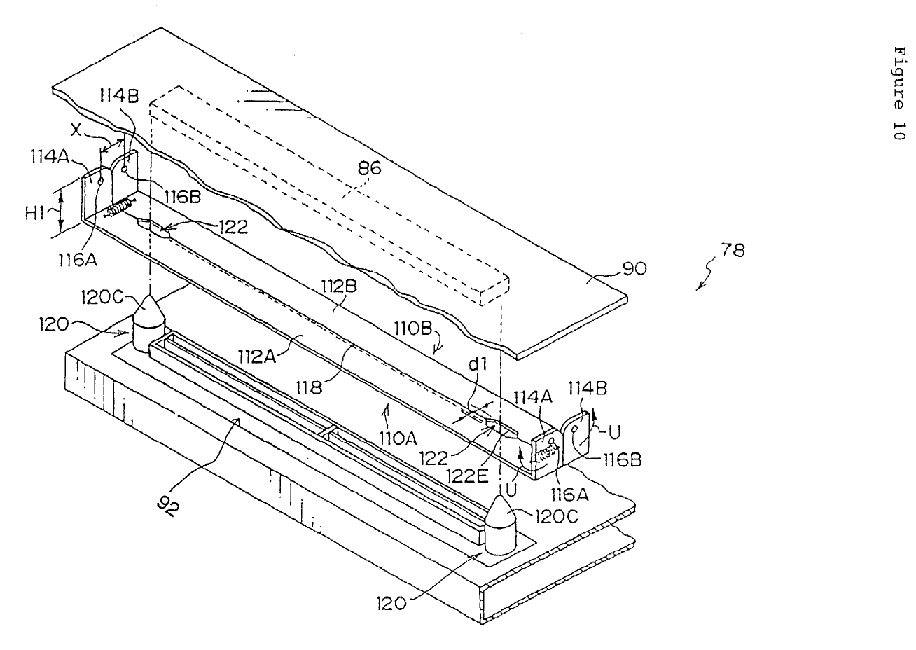

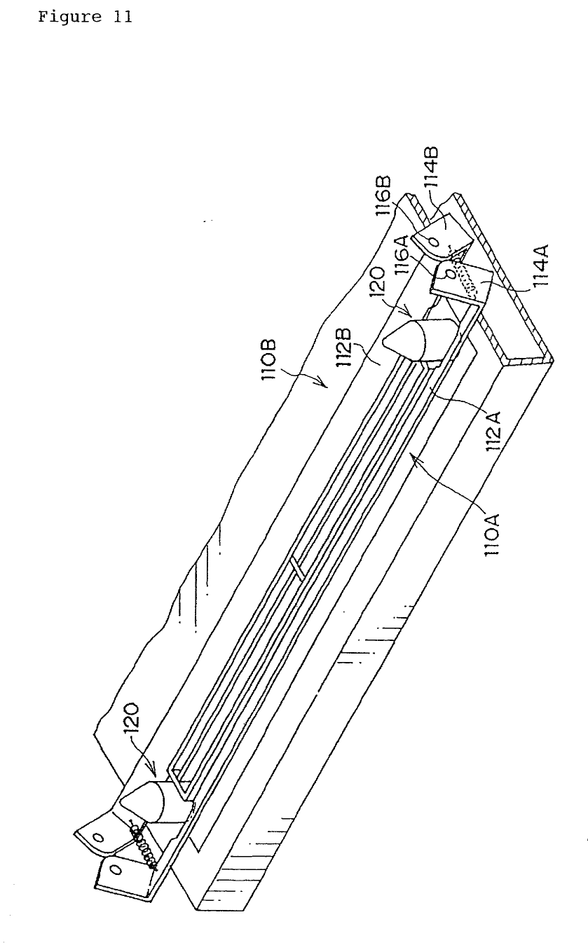

In addition, insertion mouth 58 elongated in the direction of rotation W is formed in the abutting surfaces 54 of the flaps 40A, 40B. The spacing d2 between the opposite edges of the insertion mouth 58 in the direction of rotation W is great compared with the spacing d1 (see FIG. 10) in the conventional PC 80, and is selected so that it becomes approximately equal to the spacing L between the first shaft portion 46A and the second shaft portion 46B.

Furthermore, on one of the longitudinal end portions of the female connector 30 of the extended unit 24, a pin 60 for opening the flap 40 is provided so that it is inserted into and protrudes from the insertion mouth 58. The opening pin 60 has a flat surface 60F formed at its point end portion and also has inclined surfaces 60T, which are formed from the ends of the flat surface 60F toward the bottom and abut the edges 58E of the flaps 40A, 40B in the direction of rotation W, respectively.

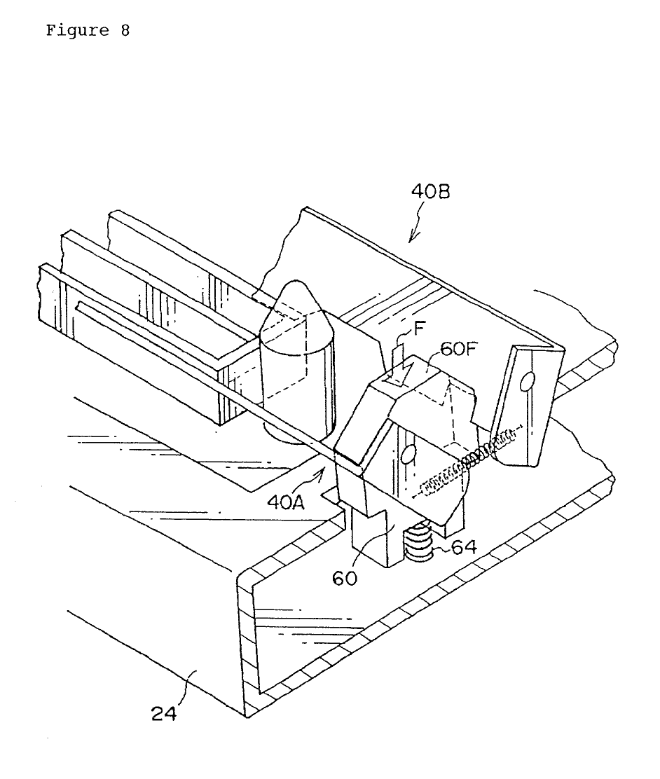

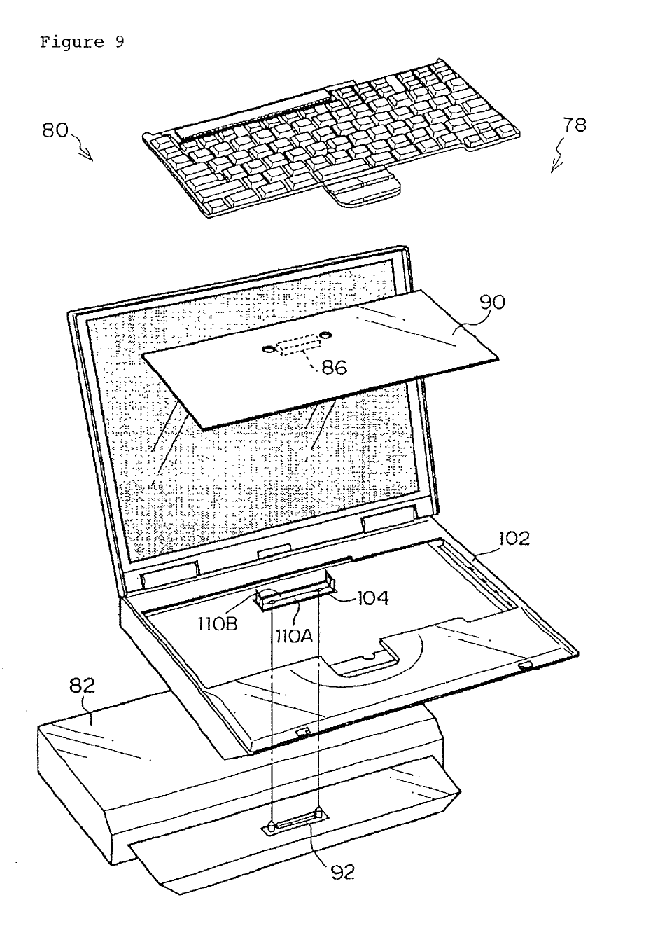

The angle formed by the inclined surface 60T and the insertion mouth 58, i.e., the angle α that the inclined surface 60T and the flap main body 42 (see FIG. 3) form, is 45 degrees. With this, the flaps 40A, 40B are easy to open. In addition, when the PC 22 and the extended unit 24 are connected, the backside of the substrate 50 in the PC 22 strikes the flat surface 60F of the opening pin 60 (see FIG. 7). This can stabilize the connected state of the connector.

Additionally, the opening pin 60 is urged in the direction of protrusion by a compression coil spring 64 so that it is movable in the up-and-down direction T. If the substrate 50 strikes the flat surface 60F and pushes the opening pin 60, it is depressed into the extended unit 24 and lowered in height. This structure is particularly useful, because a space for receiving a tall opening pin 60 is difficult to provide in a thin notebook-sized personal computer.

Note that the extended unit 24 is integrally provided on both sides of the female connector 30 with the guide pins 70, which are used for positioning the connectors but make no contribution to the operation of opening or closing the flaps.

A description will hereinafter be given in the case where the opening pin 60 is inserted into the insertion mouth 58 to open the flaps 40A, 40B.

As shown in FIG. 3, in order to connect the PC 22 with the extended unit 24, the opening 34 in the bottom portion of the PC 22 is moved near the female connector 30 of the extended unit 24 so that the opening pin 60 is positioned to the insertion mouth 58. In this positioned state, the inclined surfaces 60T of the opening pin 60 touch the edges or mouth 58E of the insertion mouth 58.

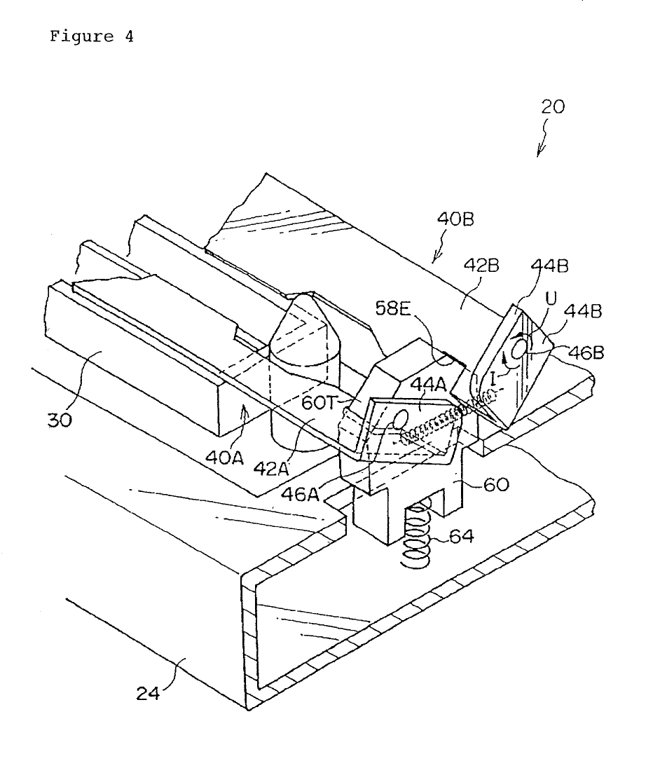

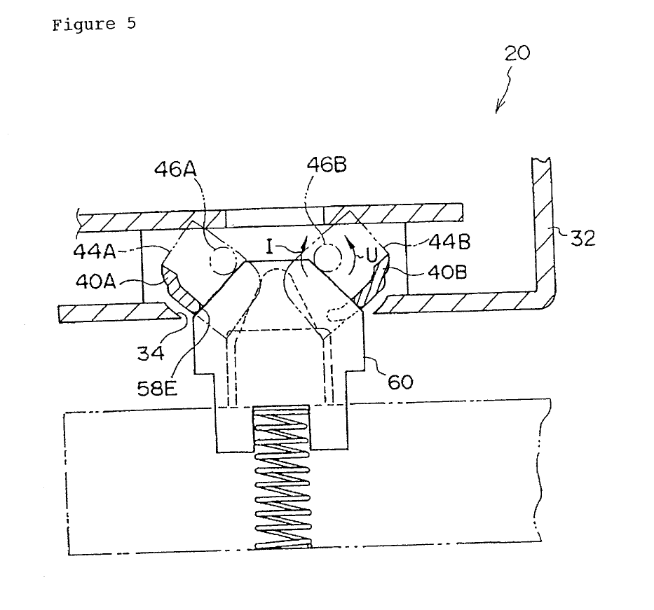

Next, if the PC 22 is lowered downward by its dead weight, force is exerted on the edges 58E, as shown in FIGS. 4 and 5. Also, moment of rotation occurs on the first shaft portion 46A and the second shaft portion 46B, and the flaps 40A, 40B are opened outside the housing 32, whereby the flaps 40A, 40B begin to open. When this occurs, the elastic force of the compression coil spring 64 is selected so that it has enough strength to prevent the opening pin 60 from being depressed.

The spacing L between the first shaft portion 46A and the second shaft portion 46B is set wide so that the flaps can maintain a predetermined opening degree, even if the height H of the rotating plates is low. The spacing between the opposite edges 58E of the insertion mouth is also set wide in accordance with the spacing L. Assuming that the positions where the opening pin 60 first touch the edges 58E of the insertion mouth are action points, it is obvious from FIG. 3 that the action point is located at positions right under the first shaft portion 46a and the second shaft portion 46b, respectively. This is important in order to cause the inclined surfaces 60T of the opening pin 60 to engage with the edges 58E of the insertion mouth so that moment of rotation is applied to the flaps in the direction of arrow U. If the spacing between the action points is too narrow compared with the spacing L, the moments of rotation that act on the flaps 40A, 40B with the first and second shaft portions as axes of rotation will be exerted in the direction of arrow I in which the flaps are rotated inward and therefore the flaps will not open.

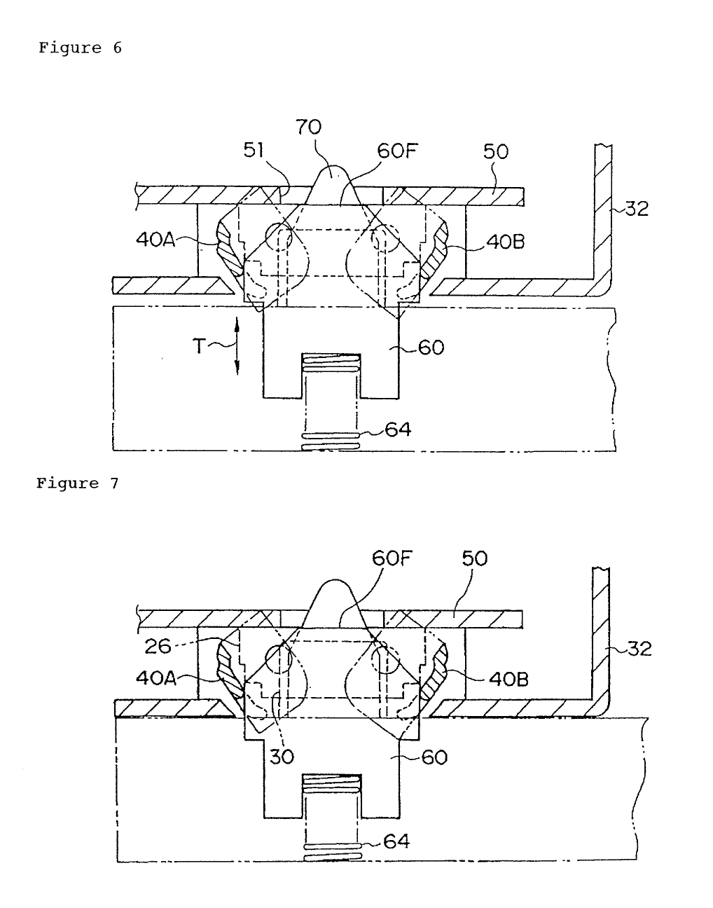

Furthermore, if the PC 22 is lowered downward, the flaps 40A, 40B are fully opened outside, as shown in FIG. 6. That is, the flaps 40A, 40B go to a fully opened state and also the substrate 50 strikes the flat surface 60F of the opening pin 60. Because of this, the opening pin 60 is pushed downward and moved downward. Note that the guide pins 70 fit into openings (not shown) in the male connector 26, whereby the positions of both connectors are accurately determined.

Furthermore, if the PC 22 is lowered, the male connector 26 and the female connector 30 are completely connected as shown in FIGS. 7 and 8. When this occurs, the opening pin 60 undergoes pushing force F (see FIG. 8) from the substrate 50 and moves downward, so there is no possibility that the engagement between the PC 22 and the extended unit 24 will be disturbed by the opening pin 60.

Note that while the insertion mouth 72 (see FIG. 2) into which the guide pins 70 of the extended unit 24 are inserted are formed in the abutting surfaces 54 of the flaps 40A, 40B, as in the conventional way, there is no possibility that the guide pins 70 will touch the opening edges of the insertion mouth 72, because the flaps 40A, 40B opens while the inclined surfaces 60T of the opening pin 60 is touching the edges 58E of the insertion mouth 58, when the flaps 40A, 40B are opened in connecting the PC 22 with the extended unit 24.

As has been described hereinbefore, in the flap opening and closing mechanism 20, the flap is fully opened by the opening pins 60 before the male connector 26 and the female connector 30 are connected, and even if the height H2 (see FIGS. 2 and 3) of the rotating plates 44 are reduced to form a thin flap opening and closing mechanism, opening and closing of the flap 40 are smoothly performed. This makes realization of the thin PC 22 possible.

In connecting a thin electronic unit and another electronic unit by connectors, the present invention is capable of providing a mechanism of opening and closing flaps which protect the connector of the thin electronic unit. Even if a thin electronic unit has no sufficient space for receiving the opening pin which opens the flaps, the opening and closing mechanism of the present invention can provide an opening and closing mechanism which is capable of opening the flaps without disturbing connection of connectors.

The embodiment above described is merely one embodiment of the present invention and the scope of the flap opening and closing mechanism according to the present invention is not limited to the above-mentioned embodiment.

What is claimed:

1. A flap actuation mechanism used in connecting a first electronic unit having a first connector and a second electronic unit having a second connector connectable with said first connector, said second electronic unit having two flaps for protecting said second connector, said mechanism comprising:
an opening pin provided by said first electronic unit, said opening pin being urged in a direction of protrusion by a spring and operable to open said two flaps during connection of said first electronic unit and said second electronic unit, and being depressed in a direction opposite to said direction of protrusion by compression of said spring when said first connector and said second connector are engaged;
an insertion mouth formed in abutting surfaces of said two flaps and positioned to engage with said opening pin during connection of said first electronic unit and said second electronic unit.

2. The flap actuation mechanism according to claim 1, wherein said first connector is provided integrally with guide pins, and said second connector is provided integrally with holes into which said guide pins are fitted.

3. The flap actuation mechanism according to claim 1, wherein said opening pin has an inclined surface engageable with said insertion mouth to open said two flaps; and
said two flaps are rotatably supported on a first shaft portion and a second shaft portion respectively through rotating plates formed by bending both end portions of said two flaps.

4. The flap actuation mechanism according to claim 3, wherein an angle formed by said inclined surface and a surface of said flaps around said insertion mouth is in a range of 30 to 60 degrees.

5. The flap actuation mechanism according to claim 1, wherein said first electronic unit is an extended unit and said second electronic unit is a portable personal computer.

6. An electronic unit comprising a housing defining an opening at a connector, said opening being protected by two flaps, said electronic unit being connectable with a separate electronic unit having a complementary connector connectable with said connector of said electronic unit and also having an opening pin, said opening pin being urged in a direction of protrusion by a spring and also opening said two flaps during connection of said electronic unit and said separate electronic unit, said opening pin being depressed in a direction of said connected electronic unit by compression of said spring when said connector and said complementary connector are engaged;
said electronic unit further comprising an insertion mouth formed in abutting surfaces of said two flaps to engage with said opening pin during connection of said electronic unit and said separate electronic unit.

7. The electronic unit according to claim 6, wherein said electronic unit is a portable personal computer and said separate electronic unit is an extended unit.

8. An electronic unit comprising a first connector connectable with a second connector provided in a separate electronic unit, said separate electronic unit comprising a housing having an opening formed at said second connector, two flaps formed to close said opening, and an insertion mouth formed in abutting surfaces of said two flaps, said electronic unit further comprising:
an opening pin urged in a direction of protrusion by a spring, said opening pin being adapted to engage said insertion mouth to open said two flaps during connection of said electronic unit and said separate electronic unit; and being depressed in a direction of said electronic unit by compression of said spring when said opening pin strikes an inner portion of said separate electronic unit.

9. The electronic unit according to claim 8, wherein said electronic unit is an extended unit and said separate electronic unit is a portable personal computer.
